(19) United States
(12) Patent Application Publication
(10) Pub. No.: US 2007/0268543 A1
(43) Pub. Date: Nov. 22, 2007

(54) Mirror structure and optical scanner having the same

(75) Inventors: Jin Woo Cho, Seongnam-si (KR); Jin Ho Lee, Suwon-si (KR); Seok Jin Kang, Suwon-si (KR); Hyun Ku Jeong, Chungiu-si (KR); Seok Whan Chung, Suwon-si (KR); Young Chul Ko, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTGRONICS CO., LTD.

(21) Appl. No.: 11/540,656

(22) Filed: Oct. 2, 2006

(30) Foreign Application Priority Data
May 16, 2006 (KR) 10-2006-0043773

(51) Int. Cl. G02B 26/08

(52) U.S. Cl. 359/224; 359/199

(57) ABSTRACT

A mirror structure and an optical scanner having the same which may achieve a high resolution since dynamic deformation is small while having a large driving angle. A plurality of vertical ribs are formed in a rear of the mirror of a scanner that reflects light, and are vertical to a torsional axis which is a center of vibration of the mirror. A horizontal rib is spaced apart from the torsional axis by a predetermined distance, and vertical to the vertical ribs. Optimum design parameters such as a size of the mirror, a moment of inertia, a driving angle, and dynamic deformation which are relevant to each other may be derived. Accordingly, the mirror may rotate at high speed and emit an image signal to a precise location.

### CROSS-REFERENCE TO RELATED APPLICATION

This application claims priority from Korean Patent Application No. 10-2006-0043773, filed on May 16, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a mirror structure and an optical scanner having the same, and more particularly, to a mirror structure and an optical scanner having the same, which have small dynamic deformation while having a large driving angle, and thereby may obtain a high resolution.

2. Description of Related Art

An optical scanner is usually used to change the path of a laser beam. The optical scanner may be commonly used for a laser printer, a bar code reader, and the like. Also, the optical scanner may have complicated uses for a complex image processing apparatus such as a laser television or the like. A laser beam is usually provided along a straight path. Accordingly, a desired image may be obtained by projecting a laser beam to an external screen after changing a path of the laser beam by using the optical scanner.

The optical scanner includes a mirror which is manufactured based on the micro electromechanical system (MEMS) technology. A method of using two mirrors working with two respectively different axes so as to change the path of a laser beam is known in a related art. Also, a method of two-dimensionally changing the path of a laser beam by moving one mirror with two axes is known in a related art.

FIG. 1 is a perspective view illustrating a MEMS scanner which is disclosed in Korean Patent Publication No. 10-2005-0053053 which has been filed by Applicant of the present invention.

As illustrated, a mirror 10 is formed in an approximate circular shape. The mirror 10 rotates on two spring portions 20 and 20′ within a range of a predetermined angle. The two spring portions 20 and 20′ support the mirror 10. Also, when the mirror 10 is rotating, the two spring portions 20 and 20′ are in a torsion motion.

A connecting portion 30 connects the mirror 10 and the two spring portions 20 and 20′. The connecting portion 30 is formed in an approximate oval shape. A movable comb 40 is formed on an outer side of the connecting portion 30. A plurality of comb-fingers are provided at predetermined intervals on the movable comb 40. In this instance, a fixed comb generating an electrostatic force with the movable comb 40 is provided to be corresponding to the movable comb 40, which is not shown.

When a force is generated in the fixed comb and a driving power is transferred to the movable comb 40, a mirror including the mirror 10 rotates with a desired driving angle. Light entering from a light source is reflected and emitted to a desired location of a screen by the mirror portion 10. In this instance, an image signal may be generated. An electrostatic method as described above may enable low power consumption, and allow comparatively easy manufacturing of the mirror.

A related art mirror structure has a satisfactory performance for a video graphics adapter (VGA). However, the related art mirror structure may not generate an image of high definition (HD) for a higher resolution.

In order to obtain an HD image resolution, a size of a mirror and a driving angle should be increased. As an example, in order to obtain an HD image quality, a diameter of the mirror should be increased from about 1.0 mm in the related art art to about 1.5 mm. Also, the driving angle should be increased from 8° in the related art art to 15°.

However, as the mirror moves at a high speed and the diameter of the mirror becomes larger, dynamic deformation also becomes larger. Required maximum dynamic deformation may be less than approximately one sixth of a laser beam wavelength or desirably one tenth of the laser beam wavelength so that an optical signal can be emitted to a desired location. However, the related art mirror structure may not satisfy this requirement. When red, green, and blue (RGB) colors are used as a light source, required maximum dynamic deformation may be less than 45 nm which is about one tenth of 450 nm. In this instance, the 450 nm indicates a wavelength of the color green.

In order to reduce dynamic deformation, a moment of inertia may be required to become high by increasing a thickness of the mirror. However, a high moment of inertia may cause an increase of rigidity of the mirror, and the driving angle of the mirror with respect to an identical torque becomes smaller. Accordingly, a high moment of inertia is not a suitable solution.

Namely, a driving angle, a size of a mirror, and dynamic deformation are relevant to each other and affect each other. Accordingly, development of an optimum mirror structure is highly required.

### SUMMARY OF THE INVENTION

The present invention provides a mirror structure and an optical scanner having the same, which have small dynamic deformation while having a relatively large mirror and a relatively large driving angle, and thereby may obtain a high resolution.

The present invention also provides a mirror structure and an optical scanner having the same, which may be easily manufactured and enable low power consumption.

The present invention also provides a mirror structure and an optical scanner having the same, which derives optimum design values of the factors for the mirror structure such as a size of the mirror, a moment of inertia, a driving angle, and dynamic deformation which are relevant to each other, and thereby may enable the mirror to quickly rotate and emit an image signal to a precise location.

According to an aspect of the present invention, there is provided a mirror structure of a scanner emitting light, the mirror structure including: a vibrating mirror which reflects the light; a torsional axis connected with a sideface of the mirror, and twisted if the mirror is vibrating; a plurality of vertical ribs which are provided in a rear of the mirror, and vertical to the torsional axis; and at least one horizontal rib which is spaced apart from the torsional axis by a predetermined distance, and vertical to the vertical ribs.

The mirror is in a shape of a disc having diameter of between about 1.2 mm and about 2.0 mm, and the predetermined distance between the torsional axis and the horizontal rib may be between about 0.55 mm and about 0.85 mm. Also, a ratio of a diameter of the mirror to the predetermined distance may be between 0.4 and 0.6. In this instance, a width of each of the vertical ribs may be between about 20 μm and about 40 μm, a pitch of the vertical ribs may be between about 100 μm and about 140 μm, a thickness of the mirror may be between about 20 μm and about 40 μm, and a sum of the thickness of the mirror and a height of each of the vertical ribs may be between about 100 μm and about 140 μm.

The vertical ribs and the horizontal rib are formed by etching the rear of the mirror. Also, the torsional axis further includes a spring axis having a smaller diameter than a diameter of the torsional axis in both elongated ends of the torsional axis. In this instance, a length of the torsional axis may be between about 2000 μm and about 3000 μm, a length of the spring axis may be between about 650 μm and about 820 μm, and a width of the spring axis may be between about 50 μm and about 120 μm.

According to another aspect of the present invention, there is provided an optical scanner including: a mirror; a torsional axis which supports the mirror; a plurality of comb axes which are respectively parallel to the torsional axis; a plurality of comb fingers which are protruded from at least one side of at lease one of the comb axes; a fixed comb which generates a force with the plurality of comb fingers; a plurality of vertical ribs which are provided in a rear of the mirror, and vertical to the torsional axis; and at least one horizontal rib which is spaced apart from the torsional axis by a predetermined distance, and vertical to the vertical ribs. In this instance, a width of each of the comb fingers may be between about 4 μm and about 10 μm, a length of a protruding portion of each of the comb fingers may be between about 100 μm and about 170 μm, and a gap between the comb fingers may be between about 2 μm and about 10 μm. As configured above, a high resolution may be obtained since dynamic deformation is small, while a size of a mirror is big and a driving angle is large. Also, a scanner which is operated in an electrostatic method may be easily manufactured and designed in an optimum condition. Accordingly, manufacturing productivity may be great and power consumption may be low.

### BRIEF DESCRIPTION OF THE DRAWINGS

The above and/or other aspects of the present invention will become apparent and more readily appreciated from the following detailed description, taken in conjunction with the accompanying drawings, in which:

FIG. 1 is a perspective view illustrating a MEMS optical scanner which is disclosed in Korean Patent Publication No. 10-2005-0053053 which has been filed by Applicant of the present invention;

FIG. 2 is a perspective view illustrating a front of a mirror structure according to an exemplary embodiment of the present invention;

FIG. 3 is a perspective view illustrating a rear of a mirror structure according to an exemplary embodiment of the present invention;

FIG. 4 is a partial enlarged perspective view illustrating a rear of a mirror structure according to an exemplary embodiment of the present invention;

FIG. 5 is a graph illustrating dynamic deformation according to a moment of inertia as values of factors for mirror deformation vary according to an exemplary embodiment of the present invention;

FIG. 6 is a graph illustrating dynamic deformation according to a spaced distance from a central axis according to an exemplary embodiment of the present invention;

FIG. 7 is a partially enlarged perspective view illustrating a spring axis according to an exemplary embodiment of the present invention; and

FIG. 8 is a graph illustrating a change of a driving angle according to a length of a spring axis according to an exemplary embodiment of the present invention.

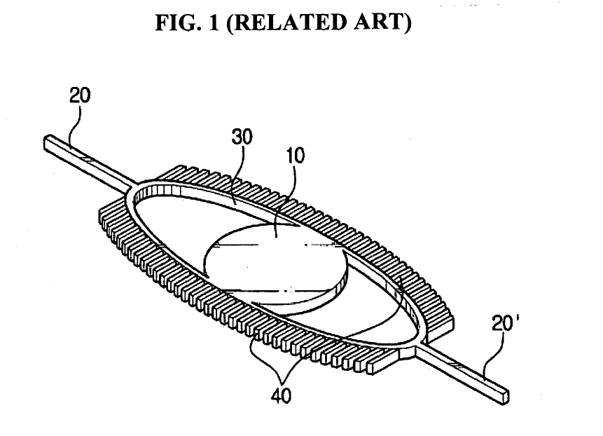

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

In the exemplary embodiments of the present invention, a mirror structure of a scanner using an electrostatic method is illustrated. However, the present invention is not limited thereto, and it will be apparent that the present invention may be widely applicable to any type of actuators which can be driven by an external input.

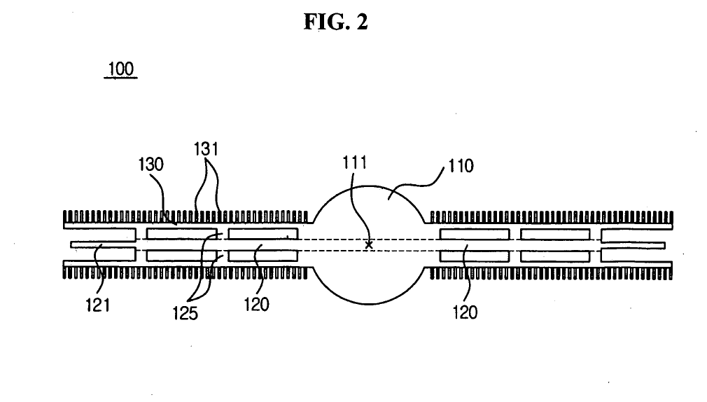

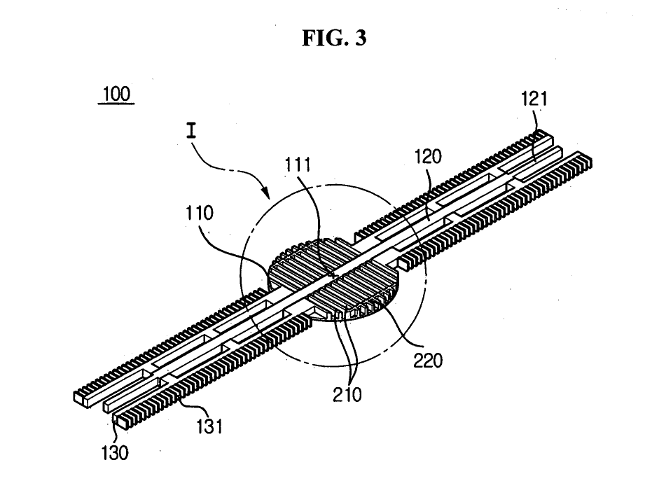

FIG. 2 is a perspective view illustrating a front of a mirror structure according to an exemplary embodiment of the present invention and FIG. 3 is a perspective view illustrating a rear of a mirror structure according to an exemplary embodiment of the present invention.

As illustrated, the mirror structure 100 includes a mirror 110 which reflects light from a light source. The mirror 110 is in a shape of a disc. Also, a front surface of the mirror 110 is made of a material which reflects the light. A diameter of the mirror 110 may be adjusted according to a wavelength of the light which is desired to be used. However, the diameter of the mirror 110 may be between about 1.2 mm and about 2.0 mm. A plurality of vertical ribs 210 and horizontal ribs 220 are formed in a rear of the mirror 110, which will be described below.

A torsional axis 120 is a shape of a bar, and passes through a center 111 of the mirror 110. The mirror 110 may vibrate in a predetermined frequency with the torsional axis 120 as a center according to the external input. In this instance, the torsional axis 120 vibrates the mirror 110 according to a received torsion.

The torsional axis 120 includes a spring axis 121 having a smaller diameter than the diameter of the torsional axis 120 in both elongated ends of the torsional axis 120. The spring axis 121 is connected to and fixed by an anchor which is not shown. The torsional axis 120 may be a shape of a cuboid whose cross section is in a rectangle shape.

Two comb axes 130 are extended from each sideface of the mirror 110 such that each comb axis is spaced apart from the torsional axis 120 by a predetermined distance, and respectively parallel to both sides of the torsional axis 120. A plurality of comb fingers 131 are protruded from a side of each comb axis 130 and provided at predetermined intervals. The plurality of comb fingers 131 are provided close to a fixed comb which is not shown. Also, the plurality of comb fingers 131 generate a force with the fixed comb, and transmit a driving power which enables the mirror 110 to vibrate.

The torsional axis 120 and the comb axes 130 are connected by a plurality of connecting axes 125 which are provided at predetermined intervals. In this instance, the connecting axes 125 are vertical to the torsional axis 120 and the comb axes 130.

A plurality of vertical ribs 210 and horizontal ribs 220 are formed in the rear of the mirror 110. The plurality of vertical ribs 210 are provided in the rear of the mirror 110, and vertical to the torsional axis 120. Also, each of the horizontal ribs 220 is spaced apart from the torsional axis 120 by a predetermined distance, and vertical to the vertical ribs 210.

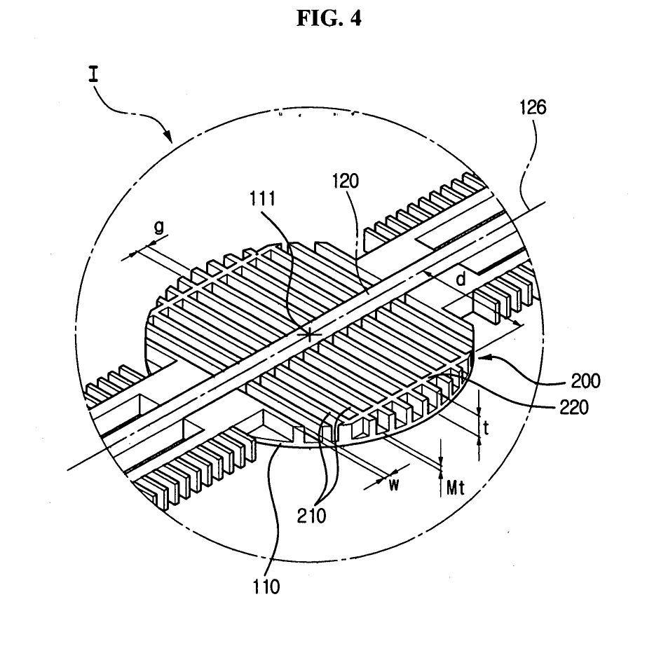

An enlarged illustration of the rear of the mirror 110 having the vertical ribs 210 and the horizontal ribs 220 is shown in FIG. 4. As illustrated, the plurality of vertical ribs 210 have a predetermined width “w” and are spaced apart from each other by a predetermined pitch “g”. Each of the horizontal ribs 220 is spaced apart from a central axis 126 by a predetermined distance “d”. Also, each of the horizontal ribs 220 is vertical to the vertical ribs 210. In this instance, the central axis 126 is a virtual axis which passes the center of the mirror 111 and passes through a center of the torsional axis 120. “Mt”, which is not described, indicates a thickness of the mirror 110. Also, “t”, which is not described, indicates a sum of the thickness of the mirror “Mt” and a height of the vertical ribs 210.

In a related art art, when operating, factors which affect a moment of inertia and dynamic deformation include the width of the vertical ribs “w”, the pitch of the vertical ribs “g”, the distance between the central axis and each of the horizontal ribs “d”, a thickness of the mirror “Mt”, and the sum of the height of the vertical rib and the thickness of the mirror “t”. Namely, when operating, the driving angle of the mirror should be large since the moment of inertia is low. However, in this instance, the dynamic deformation should be less than 4 predetermined limit. Accordingly, an optimum condition should be ascertained to prevent contradictory requirements.

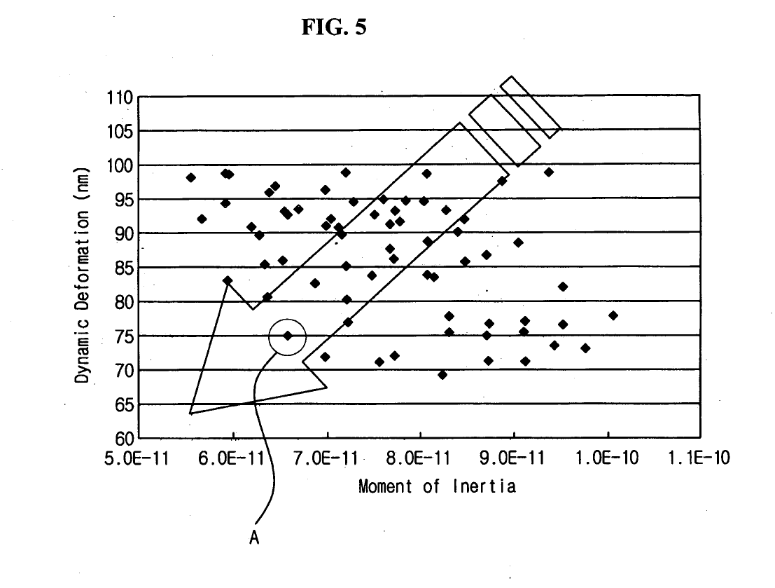

FIG. 5 is a graph illustrating dynamic deformation according to a moment of inertia as values of factors for mirror deformation vary, according to an exemplary embodiment of the present invention.

For a desirable design, factors which decrease the moment of inertia and the dynamic deformation should be ascertained. Namely, when operating, a driving angle of the mirror should be greater than a certain level since the moment of inertia is low. Also, the dynamic deformation should be small for the mirror to emit the reflected light to a desired location. Through these conditions, a high resolution may be achieved. Optimum design to satisfy the above conditions may be achieved at point “A” in FIG. 5.

For an optimum design, a planning method testing, and the like, should be used to acquire optimum values of the factors. As an example, when a diameter of the mirror is between about 1.2 mm and about 2.0 mm, a width of the vertical rib “w” may be between about 20 μm and about 40 μm, a pitch “g” of a plurality of vertical ribs may be between about 100 μm and about 140 μm, a thickness of the mirror “Mt” may be between about 20 μm and about 40 μm, and a sum of the height of the vertical rib and the thickness of the mirror “t” may be between about 100 μm and about 140 μm.

The vertical ribs are formed by etching a silicon wafer, which may decrease the moment of inertia of the mirror. However, the vertical rib is not the only element to determine the dynamic deformation. A top of the vertical rib is connected with the mirror, and the thickness of the mirror is decreased by between about 20 μm and about 40 μm due to the etching. Accordingly, a rigidity of the mirror is low, and required dynamic deformation is not satisfied. Thus, a horizontal rib connecting the vertical rib in a vertical direction is needed. In this instance, connecting a plurality of horizontal ribs causes an increase of the moment of inertia of the mirror, and thereby may not obtain a desired driving angle.

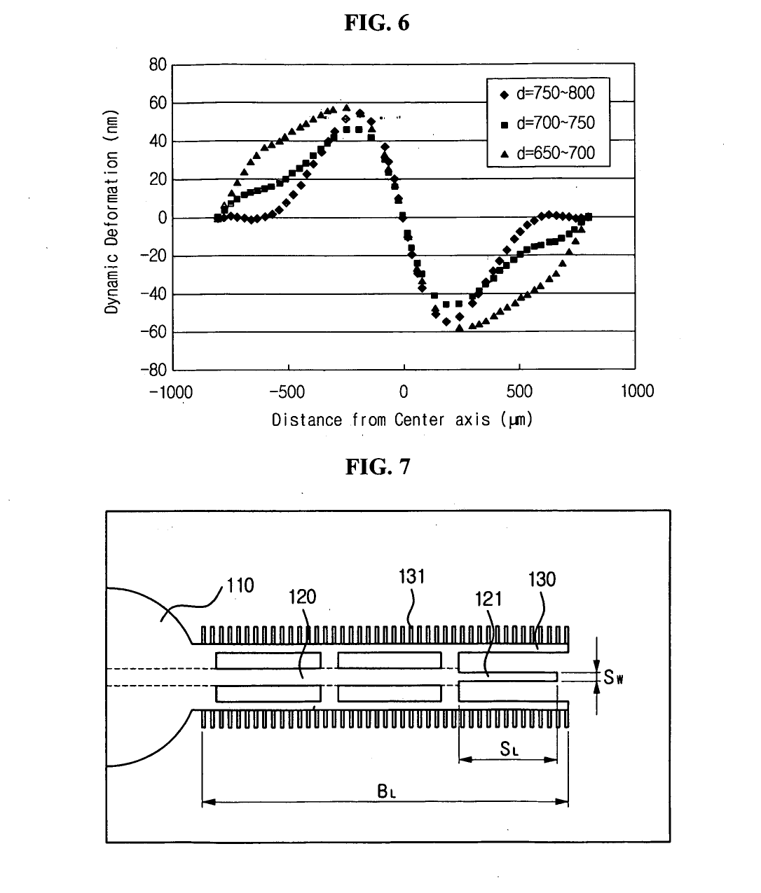

Accordingly, one horizontal rib is provided on each side of the mirror and a location of the horizontal rib is optimized, and thereby minimizing the dynamic deformation in an exemplary embodiment of the present invention. A spaced distance between the horizontal rib and a central axis “d” is a critical variable, which is illustrated in FIG. 6.

FIG. 6 is a graph illustrating dynamic deformation according to a spaced distance from the central axis according to an exemplary embodiment of the present invention. As illustrated, a diameter of a mirror 110 may be adjusted according to a wavelength of light which is desired to be used. However, when the diameter of the mirror 110 is between about 1.2 mm and about 2.0 mm, a spaced distance between a central axis and a horizontal rib “d” is between about 550 μm and about 850 μm.

Namely, a rigidity changes according to the spaced distance, and the dynamic deformation changes. When the spaced distance “d” is between about 550 μm and about 850 μm, or particularly, between about 700 μm and about 750 μm, the dynamic deformation becomes a minimum. Namely, the dynamic deformation is less than 45 nm which is about one tenth of 450 nm. In this instance, the 450 nm indicates a wavelength of the color green. As described above, the diameter of the mirror may change based on a wavelength or an image quality. However, a ratio of the spaced distance “d” and the diameter of the mirror may be between 0.4 and 0.6. In this instance, a width of the horizontal rib is between about 20 μm and about 40 μm, and a height of the horizontal rib is between about 80 μm and about 110 μm.

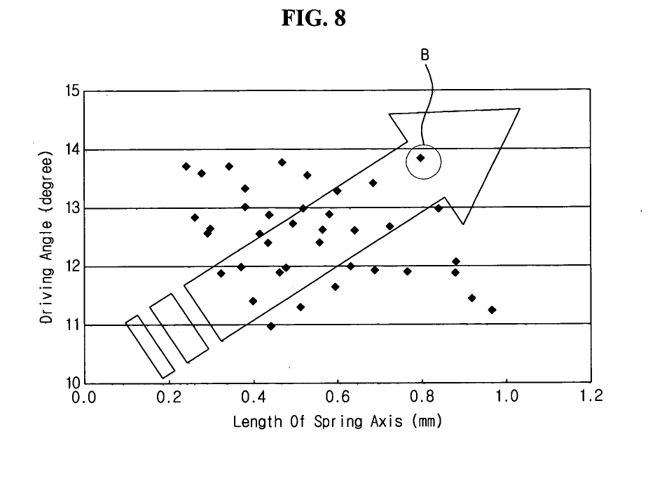

Also, after optimizing the mirror, a design of a comb axis and a plurality of comb fingers should be optimized, and a driving angle should be maximized. In order to describe the design, FIGS. 7 and 8 are provided. FIG. 7 is a partially enlarged perspective view illustrating a spring axis according to an exemplary embodiment of the present invention. FIG. 8 is a graph illustrating a change of a driving angle according to a length of a spring axis.

As illustrated in FIG. 7, “SW” indicates a width of a spring axis 121, “SL” indicates a length of the spring axis 121, and “BL” indicates a length of a comb axis 130. As described above, the comb finger 131 is provided close to a fixed comb which is not shown. Also, the comb finger 131 generates a force with the fixed comb, and transmits a driving power which enables the mirror 110 to vibrate. Also, the spring axis 121 and a torsional axis 120 vibrate the mirror 110 according to a received torsion. In this instance, a torsional stress should be less than 1 GPa. The width of the spring axis “SW”, the length of the spring axis “SL”, and the length of the comb axis “BL” are factors which affect the torsional stress.

As illustrated in FIG. 8, a driving angle should be maximized and the torsional stress should be minimized. Namely, when the driving angle is greater than a desired level and the torsional stress is less than a certain amount, the mirror structure is safe from a breakage.

For an optimum design, a planning method testing, and the like, should be used to acquire optimum values of the factors. An optimum design to satisfy the optimum values of the factors may be achieved at point “B” in FIG. 8.

Specifically, when a length of the comb axis (BL) is between about 2000 μm and about 3000 μm, a length of the spring axis may be between about 650 μm and about 820 μm, and a width of the spring axis may be between about 50 μm and about 120 μm. Also, a width of the comb finger may be between about 4 μm and about 10 μm, a length of a protruding portion of the comb finger may be between about 100 μm and about 170 μm, and a gap between a plurality of comb fingers may be between about 2 μm and about 10 μm.

Accordingly, due to the optimum design, the driving angle and the torsional stress may meet the desired level, while dynamic deformation is small. Also, an optical scanner using an electrostatic method to obtain a high resolution may be easily manufactured.

Accordingly, according to the exemplary embodiments of the present invention, a high resolution may be achieved, since dynamic deformation is small while having a relatively large mirror and a relatively large driving angle.

According to the exemplary embodiments of the present invention, an optical scanner using an electrostatic method may be easily manufactured, manufacturing productivity of the scanner may be high, and power consumption may be low due to a design in an optimum condition.

According to the exemplary embodiments of the present invention, optimum design values of the factors for a mirror structure such as a size of a mirror, a moment of inertia, a driving angle, and dynamic deformation which are relevant to each other may be derived, and a mirror may rotate at high speed and emit an image signal to a precise location, thereby achieving a high resolution.

Although a few exemplary embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A mirror structure of a scanner emitting light, the mirror structure comprising:
a vibrating mirror which reflects the light;
a torsional axis connected with a sideface of the mirror, and twisted when the mirror is vibrating;
a plurality of vertical ribs which are provided in a rear of the mirror, and vertical to the torsional axis; and
at least one horizontal rib which is spaced apart from the torsional axis by a predetermined distance, and vertical to the vertical ribs.

2. The mirror structure of claim 1, wherein the mirror is in a shape of a disc having diameter of between about 1.2 mm and about 2.0 mm, and the predetermined distance between the torsional axis and the horizontal rib is between about 0.55 mm and about 0.85 mm.

3. The mirror structure of claim 2, wherein a width of each of the vertical ribs is between about 20 μm and about 40 μm, a pitch of the vertical ribs is between about 100 μm and about 140 μm, a thickness of the mirror is between about 20 μm and about 40 μm, and a sum of the thickness of the mirror and a height of the each of the vertical ribs is between about 100 μm and about 140 μm.

4. The mirror structure of claim 1, wherein the mirror is in a shape of a disc, and a ratio of the predetermined distance to a diameter of the mirror is between 0.4 and 0.6.

5. The mirror structure of claim 4, wherein a width of each of the vertical ribs is between about 20 μm and about 40 μm, a pitch of the vertical ribs is between about 100 μm and about 140 μm, a thickness of the mirror is between about 20 μm and about 40 μm, and a sum of the thickness of the mirror and a height of the each of the vertical ribs is between about 100 μm and about 140 μm.

6. The mirror structure of claim 1, wherein the vertical ribs and the horizontal rib are formed by etching the rear of the mirror.

7. The mirror structure of claim 1, wherein the torsional axis further comprises a spring axis having a smaller diameter than a diameter of the torsional axis in both elongated ends of the torsional axis.

8. The mirror structure of claim 7, wherein a length of the torsional axis is between about 2000 μm and about 3000 μm, a length of the spring axis is between about 650 μm and about 820 μm, and a width of the spring axis is between about 50 μm and about 120 μm.

9. The mirror structure of claim 1, wherein a moment of inertia, a driving angle, and dynamic deformation of the mirror are determined according to at least one of a diameter of the mirror, a width of each of the vertical ribs, a pitch of the vertical ribs, a thickness of the mirror, and a sum of the thickness of the mirror and a height of the each of the vertical ribs.

10. The mirror structure of claim 1, wherein a diameter of the mirror is adjusted according to a wavelength of the light.

11. The mirror structure of claim 1, wherein the mirror is configured such that dynamic deformation of the mirror, when operating, is set less than one tenth of a wavelength of the light.

12. An optical scanner comprising:
a mirror;
a torsional axis which supports the mirror;
a plurality of comb axes which are respectively parallel to the torsional axis;
a plurality of comb fingers which are protruded from at least one side of at lease one of the comb axes;
a fixed comb which generates a force with the plurality of comb fingers;
a plurality of vertical ribs which are provided in a rear of the mirror, and vertical to the torsional axis; and
at least one horizontal rib which is spaced apart from the torsional axis by a predetermined distance, and vertical to the vertical ribs.

13. The optical scanner of claim 12, wherein the mirror is in a shape of a disc having diameter of between about 1.2 mm and about 2.0 mm, and the predetermined distance between the torsional axis and the horizontal rib is between about 0.55 mm and about 0.85 mm.

14. The optical scanner of claim 13, wherein a width of each of the vertical ribs is between about 20 μm and about 40 μm, a pitch of the vertical ribs is between about 100 μm and about 140 μm, a thickness of the mirror is between about 20 μm and about 40 μm, and a sum of the thickness of the mirror and a height of the each of the vertical ribs is between about 100 μm and about 140 μm.

15. The optical scanner of claim 12, wherein the mirror is in a shape of a disc, and a ratio of the predetermined distance to a diameter of the mirror is between 0.4 and 0.6.

16. The optical scanner of claim 12, wherein the torsional axis further comprises a spring axis having a smaller diameter than a diameter of the torsional axis in both elongated ends of the torsional axis.

17. The optical scanner of claim 12, wherein a length of the comb axis is between about 2000 μm and about 3000 μm, a length of the spring axis is between about 650 μm and about 820 μm, and a width of the spring axis is between about 50 μm and about 120 μm.

18. The optical scanner of claim 17, wherein a width of each of the comb fingers is between about 4 μm and about 10 μm, a length of a protruding portion of the each of the comb fingers is between about 100 μm and about 170 μm, and a gap between the comb fingers is between about 2 μm and about 10 μm.

19. The optical scanner of claim 12, wherein a torsional stress is adjusted to less than 1 GPa,
wherein the torsional stress is determined according to at least one of a length of the spring axis, a width of the spring axis, and a length of a protruding portion of the each of the comb fingers.

20. The optical scanner of claim 12, wherein a moment of inertia, a driving angle, and dynamic deformation of the mirror are determined according to at least one of a diameter of the mirror, a width of each of the vertical ribs, a pitch of the vertical ribs, a thickness of the mirror, a sum of the thickness of the mirror, a height of the each of the vertical ribs, a length of the comb axis, a length of the spring axis, a width of the spring axis, a width of each of the comb fingers, a length of a protruding portion of the each of the comb fingers, and a gap between the comb fingers.

21. The optical scanner of claim 12, wherein the vertical ribs and the horizontal rib are formed by etching the rear of the mirror.
